(19) United States
(12) Patent Application Publication
(10) Pub. No.: US 2011/0088098 A1
(43) Pub. Date: Apr. 14, 2011

(54) ELECTRONIC DEVICE AND COPYRIGHT PROTECTION METHOD OF AUDIO DATA THEREOF

(75) Inventor: CHUN-TE WU, Tu-Cheng (TW)

(73) Assignee: HON HAI PRECISION INDUSTRY CO., LTD., Tu-Cheng (TW)

(21) Appl. No.: 12/889,429

(22) Filed: Sep. 24, 2010

(30) Foreign Application Priority Data
Oct. 8, 2009 (CN) 200910308083.X

(51) Int. Cl. G06F 21/24

(52) U.S. Cl. 726/26

(57) ABSTRACT

An electronic device stores audio data and digital right information, determines zero crossing rate of the audio data store in the memory module. The zero crossing rate is embedded in the audio data and indicates a rate at which the voltage of the audio data changes from positive to negative or back during a time period, the electronic device then reads the audio data, and searches special audio data in the audio data. The audio data with the zero crossing rate more than a constant is defined as the special audio data. The electronic device reads the digital copyright information, and writes the digital copyright information into the special audio data.

### BACKGROUND

1. Technical Field

Embodiments of the present disclosure relate to the security of multimedia information, and more particularly to an electronic device and copyright protection method of audio data thereof.

2. Description of Related Art

Copyright protection and ownership verification of multimedia works, such as images, audio or video works, are important aspects of the multimedia works. Traditional copyright protection technology is watermarking which embeds copyright information into analog audio signals in a way that is difficult to remove. One of the most secure techniques of the audio watermarking is spread spectrum audio watermarking (SSW). SSW hides copyright information by spreading their spectrum which is called watermark and adds it to a host signal as a watermarked signal. Spreading spectrum is done by a pseudonoise (PN) sequence.

However, if the audio files with the watermarking technology are infringed, then it is hard to discover who used the audio files illegally, therefore the audio files with watermarking technology are hard to track. Thus, the protection of the audio files is mere formality.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 shows a schematic diagram of functional modules of an electronic device of one embodiment of the present disclosure;

FIG. 2 is a flowchart of copyright protection method of audio data of one embodiment in accordance with the present disclosure;

FIG. 3 is a waveform diagram of one embodiment of original audio data;

FIG. 4 is a waveform diagram of one embodiment of audio data processed by the copyright protection method of FIG. 2; and

FIG. 5 is an effect diagram of one embodiment of audio data processed by the copyright protection method of FIG. 2.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

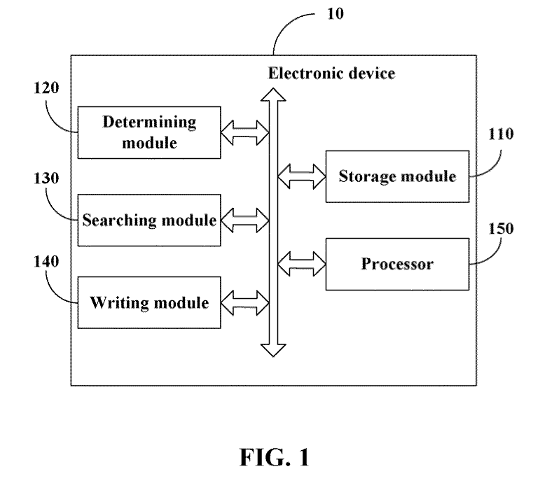

FIG. 1 shows a schematic diagram of functional modules of an electronic device 10 of one embodiment of the present disclosure. In one embodiment, the electronic device 10 hides digital copyright information in audio data. The digital copyright information is a binary number corresponding to the electronic device 10. The electronic device 10 may be a set top box, and the digital copyright information is a serial number of the set top box, for example.

In one embodiment, the electronic device 10 includes a storage module 110, a determining module 120, a searching module 130, a writing module 140 and at least one processor 150. The modules 120-140 may comprise computerized code in the form of one or more programs that are stored in the storage module 110. The computerized code includes instructions that are executed by the processor 150 to provide functions for modules 120-140.

The storage module 110 further stores the audio data and the digital copyright information. The determining module 120 determines a zero crossing rate of the audio data stored from the storage module 110. The zero crossing rate is embedded in the audio data and indicates a rate at which the voltage of the audio data changes from positive to negative or back during a time period. In one embodiment, the time period is substantially 1 ms, and the determining module 120 determines the zero crossing rate of the audio data when the audio data is played.

The searching module 130 obtains special audio data from the audio data. The audio data with the zero crossing rate more than a constant is defined as the special audio data. In one embodiment the audio data may includes a plurality of special audio data, but the searching module 130 only obtains first one of the special audio data.

The writing module 140 reads the digital information, and writes the digital information into the special audio data. The digital copyright information is a binary number including a plurality of bits. In detail, the writing module 140 reads a current bit from the digital copyright information and determines if the current bit is “1”. The writing module 140 adds a preset value to the special audio data when the current bit of the digital copyright information is “1”. In one embodiment, the preset value is a voltage value between 0.2V and 0.3V. When the current bit of the digital copyright information is “0”, the writing module 140 reads a next bit from the digital copyright information and determines if the next bit is “1”.

In this disclosure, the electronic device 10 reads the zero crossing rate of the audio data by the determining module 120, and then searches the audio data whose the zero crossing rate is more than a constant by the searching module 130, finally writes the digital copyright information into the audio data by the writing module 140. Thus, the quality of the audio data is not affected, and the copyright of audio data can be efficiently protected.

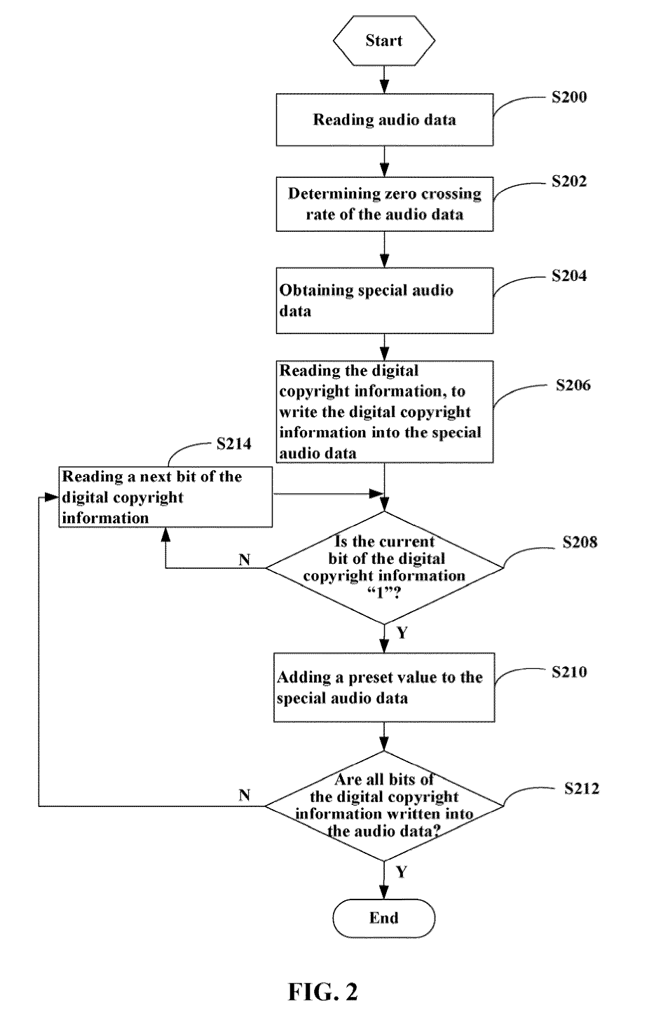

FIG. 2 is a flowchart of copyright protection method of audio data of one embodiment in accordance with the present disclosure. The method is applied in the electronic device 10 of FIG. 1, and is executed by functional modules shown in FIG. 1. Depending on the embodiment, additional blocks may be added, others deleted, and the ordering of blocks may be changed while remaining well within the scope of the disclosure.

In the block S200, the determining module 120 reads the audio data from the storage module 110.

In the block S202, the determining module 120 determines the zero crossing rate of the audio data store in the storage module 110. In one embodiment, the zero crossing rate is embedded in the audio data to indicate a rate at which the voltage of the audio data changes from positive to negative or back during one time period. In one embodiment, the time period is substantially 1 ms. The determining module 120 determines the zero crossing rate of the audio data when the audio data is played.

In the block S204, the searching module 130 obtains special audio data from the audio data. In one embodiment, the audio data with the zero crossing rate more than a constant is defined as the special audio data. In one embodiment, the audio data may include a plurality of special audio data and the searching module 130 only obtains the first one of the special audio data.

In the block S206, the writing module 140 reads the digital copyright information from the storage module 110 to write the digital copyright information into the special audio data one by one bit in subsequent blocks.

In the block S208, the writing module 140 determines if a current bit of the digital copyright information is “1”.

If the current bit of the digital copyright information is “1”, then in the block S210, the writing module 140 adds a preset value to the special audio data. In one embodiment, the preset value is a voltage value between 0.2V˜0.3V.

In the block S212, the writing module 140 determines if all bits of the digital copyright information are written into the audio data.

If not all bits of the digital copyright information are written into the audio data, in the block S214, the writing module 130 reads a next bit of the digital copyright information, and then in the block S208, the determining module 120 continues to determine if the read bit is “1”.

If the current bit of the digital copyright information is not “1”, in the block S214, the writing module 130 reads a further next bit of the digital copyright information, and the flow repeats the blocks S208˜S214 until all bits of the digital copyright information are written into the special audio data.

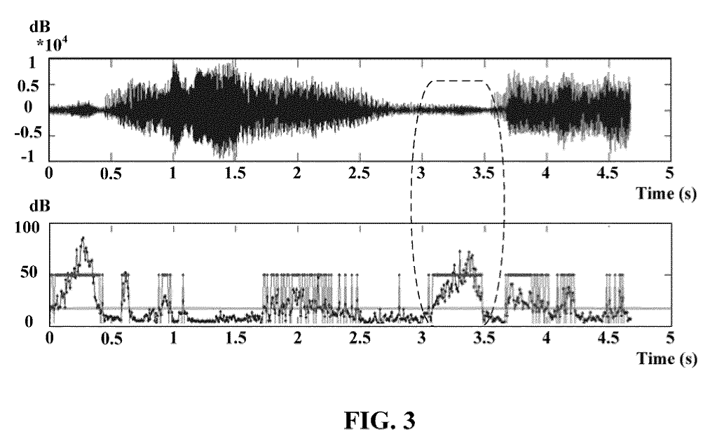

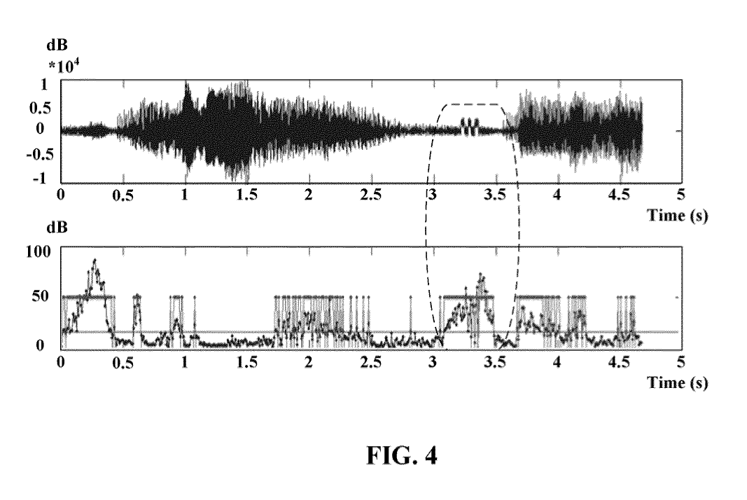

FIG. 3 is a waveform diagram of one embodiment of original audio data, and FIG. 4 is a waveform diagram of one embodiment of audio data processed by the copyright protection method of FIG. 2. In one embodiment, the zero crossing rate of the audio data is searched and then the digital copyright information is written into the special audio data, as showed within the broken line of the FIG. 3 and FIG. 4. As showed in FIG. 4, the zero crossing rate of the special audio data processed by the electronic device 10 only be changed a little bit. Therefore, writing the digital copyright information into the audio data hardly affects the audio data.

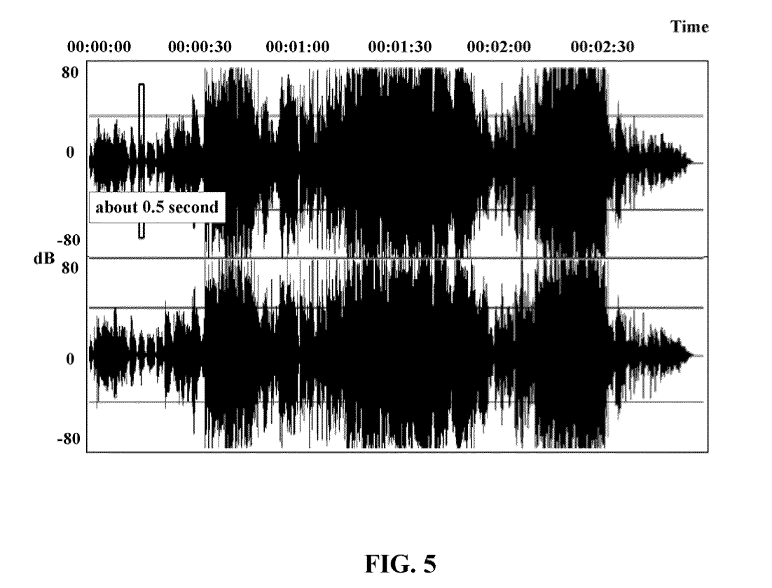

FIG. 5 is an effect diagram of one embodiment of audio data processed by the copyright protection method of FIG. 2. When the audio data is opened by the audio editor software, it can be seen that it is very hard to find out the digital copyright information in the audio data. In addition, there is no difference that is audible. Therefore, the electronic device 10 protecting the audio data by the digital copyright information has no passive effect on the audio data.

The electronic device 10 and the copyright protection method of the present disclosure reads the zero crossing rate of the audio data, obtains the special audio data, and writes the digital copyright information into the special audio data. Thus, the quality of the audio data can not be affected, the copyright of audio data can be protected, and the audio data can be easily tracked.

While various embodiments and methods of the present disclosure have been described, it should be understood that they have been presented by example only and not by limitation. Thus the breadth and scope of the present disclosure should not be limited by the above-described embodiments, but should be defined only in accordance with the following claims and their equivalents.

What is claimed is:

1. An electronic device, comprising:
a processor;
a storage module storing audio data; and
one or more software programs, wherein the one or more software programs are stored in the storage module and operable to be executed by the processor, and comprise:
a determining module to determine a zero crossing rate of the audio data, wherein the zero crossing rate is embedded in the audio data to indicate a rate at which voltage of the audio data changes from positive to negative or back during one time period;
a searching module to obtain special audio data from the audio data, wherein the zero crossing rate of the special audio data is more than a constant; and
a writing module to write digital copyright information of the audio data bit by bit into the special audio data to protect copyright of the audio data, wherein the digital copyright information is a binary number corresponding to the electronic device.

2. The electronic device as claimed in claim 1, wherein the determining module further determines if a current bit of the digital copyright information is “1”.

3. The electronic device as claimed in claim 2, wherein the writing module adds a preset value to the special audio data when the current bit of the digital copyright information is “1”.

4. The electronic device as claimed in claim 3, wherein the writing module determines if all bits of the digital copyright information are written into the audio data.

5. The electronic device as claimed in claim 4, wherein the writing module further reads a next bit of the digital copyright information if not all bits of the digital copyright information are written into the audio data.

6. The electronic device as claimed in claim 2, wherein the writing module reads a next bit when the current bit of the digital copyright information is not “1”.

7. A copyright protection method of audio data by digital copyright information, the method comprises the following computer-implemented steps:
reading the audio data;
determining a reading zero crossing rate of the audio data, wherein the zero crossing rate is embedded in the audio data and indicates a rate at which voltage of the audio data changes from positive to negative or back during one time period;
obtaining special audio data from the audio data, wherein the zero crossing rate of the special audio data is more than a constant; and
reading the digital copyright information to write the digital copyright information bit by bit into the special audio data to protect copyright of the audio data.

8. The copyright protection method of audio data by digital copyright information as claimed in claim 6, wherein writing the digital copyright information bit by bit into the special audio data comprises the following computer-implemented steps:
reading a current bit of the digital copyright information and determining if the current bit of the digital copyright information is “1”;
adding a preset value to the special audio data if the current bit of the digital copyright information is “1”;
determines if all bits of the digital copyright information are written into the audio data; and
reading a next bit of the digital copyright information if not all bits of the digital information are written into the special audio data.

9. The copyright protection method of an audio data by digital copyright information as claimed in claim 7, further comprising the step of:
reading a next bit if the current bit of the digital copyright information is not “1”.
